(19) United States
(12) Patent Application Publication
(10) Pub. No.: US 2007/0147397 A1
(43) Pub. Date: Jun. 28, 2007

(54) Methods, communication networks, and computer program products for configuring a communication tunnel for traffic based on whether a network element can be trusted

(76) Inventors: Jeffrey Aaron, Atlanta, GA (US); Edgar Shrum JR., Smyrna, GA (US)

Correspondence Address: MYERS BIGEL SIBLEY & SAJOVEC, P.A., P.O. BOX 37428, RALEIGH, NC, 27627, US

(21) Appl. No.: 11/316,429

(22) Filed: Dec. 22, 2005

(51) Int. Cl. H04L 12/56

(52) U.S. Cl. 370/401; 370/252

(57) ABSTRACT

A communication network is operated by determining whether a network element can be trusted and configuring a tunnel for traffic associated with the network element based on whether the network element can be trusted operates a communication network.

### FIELD OF THE INVENTION

The present invention relates to communication networks and methods of operating the same, and, more particularly, to methods, systems, and computer program products for tunneling traffic on communication networks.

### BACKGROUND OF THE INVENTION

Entities, such as gateways, routers, switches, servers, controllers, and/or balancers, in the path(s) of a communication can be attacked and/or compromised, which may allow one or more of those entities to be used by the attacker or hacker for undesirable purposes, such as to eavesdrop on private communications and/or to modify those communications in an undesirable fashion. Moreover, these actions may be performed without anyone suspecting. No security system is perfect; therefore, it is impossible to completely prevent such security breaches from occurring. It may be possible, however, to detect when an entity or network element in a communication path has been compromised. When such a network element has been detected as being compromised, then communications using the network element may be manually disabled. Unfortunately, this may be a time consuming process that results in a potentially excessive loss of communication capability for, perhaps, many users. It may be useful to be able to tunnel through such a compromised element, but only when that element is compromised. Because tunneling may be expensive, both in terms of set-up and with regard to computing/network resources, tunneling is not always used when needed, but rather is under-used (due to lack or awareness of the specific need) or over-used (due to having only crude methods of assuming a need, and responding by using tunneling in some cases even when the specific need is not truly known).

### SUMMARY OF THE INVENTION

According to some embodiments of the present invention, a communication network is operated by determining whether a network element can be trusted and configuring a tunnel for traffic associated with the network element based on whether the network element can be trusted operates a communication network.

In other embodiments, determining whether a network element can be trusted, comprises generating a first hash value based on data associated with the network element, generating a second hash value based on the data associated with the network element, and comparing the first hash value with the second hash value to determine whether the network element can be trusted.

In still other embodiments, comparing the first hash value with the second hash value to determine whether the network element can be trusted comprises comparing the first hash value with the second hash value to determine a degree of trust for the network element.

In still other embodiments, configuring the tunnel comprises configuring the tunnel using rules that are based on the degree of trust for the network element.

In still other embodiments, configuring the tunnel comprises selecting tunnel parameters using rules that are based on the degree of trust for the network element, the tunnel parameters comprising tunnel type, tunnel endpoints, tunnel security parameters, and/or tunnel filter characteristics for admitting/denying traffic to the tunnel.

In still other embodiments, selecting tunnel security parameters comprises selecting encryption parameters, determining an impact of the security parameters on the traffic, and adjusting the encryption parameters if the impact is unacceptable.

In still other embodiments, at least one tunnel initiator and at least one tunnel end are associated with the network element, and configuring the tunnel comprises selecting one of the at least one tunnel initiator and one of the at least one tunnel end for the tunnel.

In still other embodiments, selecting one of the at least one tunnel initiator and one of the at least one tunnel end for the tunnel comprises selecting one of the at least one tunnel initiator and one of the at least one tunnel end for the tunnel that are able to implement the security parameters.

In still other embodiments, generating the first hash value and generating the second hash value comprise generating the first hash value and the second hash value responsive to at least one of an expiration of a timer, a packet count associated with the network element, an event associated with then network element, and a hash generation command.

In still other embodiments, configuring the tunnel comprises configuring a plurality of tunnels having a common initiation point for a plurality of groups of traffic, respectively, directed to different destinations; and/or configuring a plurality of tunnels having different parameters for a plurality of groups of traffic, respectively, the tunnel parameters comprising tunnel type, tunnel endpoints, tunnel security parameters, and/or tunnel filter characteristics for admitting/denying traffic to the tunnel.

In still other embodiments, the traffic is monitored through the tunnel and parameters associated with the tunnel are adjusted based on the monitored traffic, the tunnel parameters comprising tunnel type, tunnel endpoints, tunnel security parameters, and/or tunnel filter characteristics for admitting/denying traffic to the tunnel.

In still other embodiments, the network element carries the traffic within the tunnel.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of exemplary embodiments thereof when read in conjunction with the accompanying drawings, in which:

FIG. 1 is a block diagram that illustrates a communication network in accordance with some embodiments of the present invention; and

FIG. 2 is a flowchart that illustrates operations for configuring a tunnel for traffic associated with the network element based on whether the network element can be trusted in accordance with some embodiments of the present invention.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Embodiments of the present invention are described hereafter in the context of processing a packet. It will be understood that the term “packet” means a unit of information and/or a block of data that may be transmitted electronically as a whole or via segments from one device to another. Accordingly, as used herein, the term “packet” may encompass such terms of art as “frame” and/or “message,” which may also be used to refer to a unit of transmission.

In some embodiments of the present invention, a determination can be made whether a network element in a communication path can be trusted and/or to what degree the network element can be trusted. Based on this determination, a secure tunnel may be configured to convey vulnerable communications through or past the untrustworthy network element. The tunnel may be configured with a degree of data protection that is proportional to the degree to which the network element cannot be trusted. In this way, vulnerable data may be protected from undesirable potential hacking.

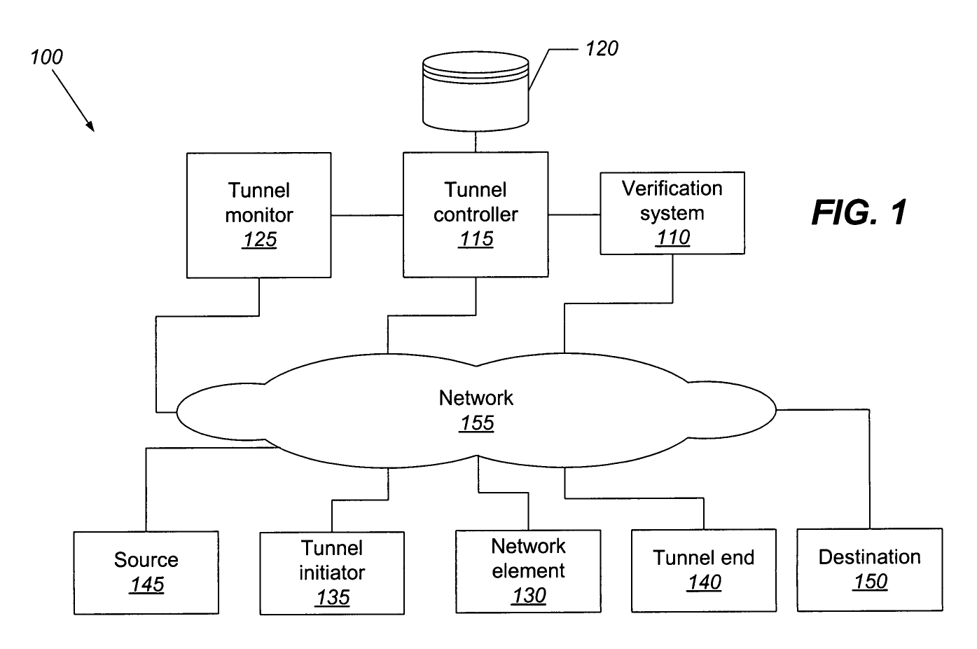

Referring now to FIG. 1, an exemplary network architecture 100 for configuring a tunnel for traffic associated with a network element based on whether the network element can be trusted, in accordance with some embodiments of the present invention, comprises a verification system 110, a tunnel controller 115, a tunnel database 120, a tunnel monitor 125, a network element 130, a tunnel initiator 135, a tunnel end 140, a communication source 145, a communication destination 150, and a network 155 that are connected as shown. The network 155 may represent a global network, such as the Internet, or other publicly accessible network. The network 155 may also, however, represent a wide area network, a local area network, an Intranet, or other private network, which may not accessible by the general public. Furthermore, the network 155 may represent a combination of public and private networks or a virtual private network (VPN).

The verification system 110 may be configured to determine whether the network element 130 is trustable or not, by, for example, determining a degree of trust for the network element 130. This trust information may then be provided to the tunnel controller 115. The verification system 110 may be embodied as described in, for example, U. S. patent application Ser. No. 10/880,249 entitled “Verification of Consumer Equipment Connected to Packet Networks Based on Hashing Values” (hereinafter '249 application), and U.S. patent application Ser. No. 10/886,169 entitled “Controlling Quality of Service and Access in a Packet Network Based on Levels of Trust for Consumer Equipment” (hereinafter '169 application), the disclosures of which are hereby incorporated herein by reference in their entireties.

As described in the '249 application and '169 application, the verification system 110 can determine a level of trust for the network element 130 by generating first and second hash values based on data that is associated with the network element 130. This data may represent any type of software and/or firmware, for example, associated with the network element 130. If the hash values are not identical, then an evaluation may be made whether the network element 130 can be trusted and/or what degree of trust may be assigned to the network element 130.

As used herein, the term “network element” includes any device that is configured to communicate traffic, such as packet traffic, using the communication network 155. Accordingly, the network element 130 may be, but is not limited to, a router, a gateway, a switching device, a cable modem, a digital subscriber line modem, a public switched telephone network modem, a wireless local area network modem, a wireless wide area network modem, a computer with a modem, a mobile terminal such as personal data assistant and/or cellular telephone with a modem. For network elements that communicate via the communication network 135 through a wireless interface, wireless protocols, such as, but not limited to, the following may be used: a cellular protocol (e.g., General Packet Radio System (GPRS), Enhanced Data Rates for Global Evolution (EDGE), Global System for Mobile Communications (GSM), code division multiple access (CDMA), wideband-CDMA, CDMA2000, and/or Universal Mobile Telecommunications System (UMTS)), a wireless local area network protocol (e.g., IEEE 802.11), a Bluetooth protocol, another RF communication protocol, and/or an optical communication protocol.

The tunnel controller 115 may be configured to obtain trust and/or degree of trust information for network element(s) 130 from the verification system 110. In some embodiments, trust-relevant information from additional sources could alternately or additionally be considered. Such additional trust-relevant sources may include, but are not limited to, various network management systems, policy-based control systems, monitoring systems, including intrusion detection/protection systems, security scanning systems, third party security notification systems, outsourced security consulting/management services/systems, and/or security relevant information aggregation systems. Based on this trust information, the tunnel controller 115 may configure a tunnel to convey traffic through the network element 130 in a secure manner. In some embodiments, the tunnel controller 115 may use rules that are stored, for example, in the tunnel database 120 to configure the tunnel based on the degree of trust obtained for the network element 130. For example, the tunnel controller 115 may use the rules to select various tunnel parameters based on the degree of trust obtained for the network element 130. These tunnel parameters may include, but are not limited to, a tunnel type (e.g., Secure Socket Layer (SSL), IPsec, etc.), tunnel endpoints (e.g., tunnel initiator 135 and tunnel end 140), tunnel security parameters, and/or tunnel filter characteristics for admitting/denying traffic to the tunnel. The security parameters may include encryption type and encryption algorithm along with such factors as encryption mode and key lengths and key updating.

The tunnel database 120 may maintain records of the network element(s) 130 in the network 155 in which the network element(s) 130 are associated with identifiers to facilitate searching for the network element(s) 130 in the database 120. In some embodiments, each network element 130 may be associated with one or more other elements that may be used to form a communication tunnel that incorporates the network element 130. These elements may be candidates for the tunnel controller 115 to select from to serve as a tunnel initiator 135 or a tunnel end 140 when forming a tunnel for a particular network element 130. The source 145 and destination 150 may represent network elements that originate and termination a communication session, respectively.

The tunnel monitor 125 may be configured to obtain information regarding the status/performance of the tunnel from the source 145, tunnel initiator 135, network element 130, tunnel end 140, and/or the destination 150. This information may be provided to the tunnel controller 115, which may then adjust or change one or more tunnel parameters so that the tunnel continues to operate in a desired manner. In other embodiments, the tunnel monitor 125 may invoke alerts and/or alarms for administrative personnel if the status/performance of the tunnel degrades to a point that intervention may be beneficial.

Although FIG. 1 illustrates an exemplary communication network, it will be understood that the present invention is not limited to such configurations, but is intended to encompass any configuration capable of carrying out the operations described herein.

The verification system 110, tunnel controller 115, and/or tunnel monitor 125 may be embodied as one or more data processing systems that comprise, for example, input device(s), such as a keyboard or keypad, a display, and a memory that communicate with a processor. Such data processing system(s) may further include a storage system, a speaker, and an input/output (I/O) data port(s) that also communicate with the processor. The storage system may include removable and/or fixed media, such as floppy disks, ZIP drives, hard disks, or the like, as well as virtual storage, such as a RAMDISK. The I/O data port(s) may be used to transfer information between the data processing system(s) and another computer system or a network (e.g., the Internet). These components may be conventional components such as those used in many conventional computing devices, which may be configured to operate as described herein. Moreover, the functionality of the verification system 110, tunnel controller 115, and/or tunnel monitor 125 may be implemented as a single processor system, a multi-processor system, or even a network of stand-alone computer systems, in accordance with various embodiments of the present invention.

Computer program code for carrying out operations of the verification system 110, tunnel controller 115, and/or tunnel monitor 125 may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

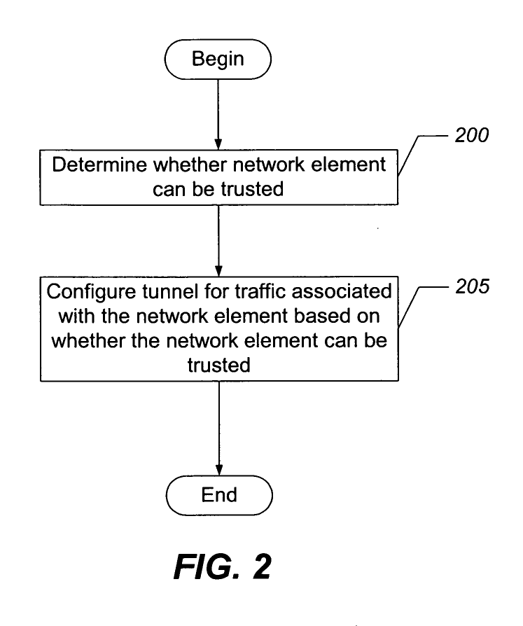

Exemplary operations for configuring a tunnel for traffic associated with a network element based on whether the network element can be trusted, in accordance with some embodiments of the present invention, will now be described with reference to FIGS. 2 and 1. Operations begin at block 200 where the verification system 110 determines whether a network element 130 can be trusted and/or to what degree that network element can be trusted. As discussed above and in detail in the '249 application and the '169 application, the verification system 110 may determine a degree of trust for a network element 130 by comparing hash values generated for data associated with the network element 130. Advantageously, the verification system 110 may be configured to automatically evaluate the network element 130 to determine a degree of trust for the network element 130. For example, the verification system 110 may generate a hash value for data associated with the network element 130 every time a timer expires, a packet count is reached, a particular event occurs at the network element 130, such as, for example, the start of a session initiation protocol (SIP) or Voice over Internet Protocol (VoIP) session, and/or a direct command to perform a hash operation on the data associated with the network element 130.

At block 205, the tunnel controller 115 configures a tunnel for traffic that is associated with the network element 130 based on whether the network element 130 can be trusted. As discussed above, the tunnel controller 115 may configure the tunnel using rules stored in the tunnel database 120 that are based on the degree of trust for the network element 130. For example, the tunnel controller 115 may use these rules to select tunnel parameters that include, but are not limited to, tunnel type, tunnel endpoints, tunnel security parameters, and/or tunnel filter characteristics for admitting/denying traffic to the tunnel. The security parameters may include encryption type and encryption algorithm along with such factors as encryption mode and key lengths and key updating.

In selecting the security parameters, the tunnel controller 115 may select a set of encryption parameters for the tunnel and then determine the impact that the security parameter have on the traffic through the tunnel. The encryption parameters may then be adjusted if the impact on the traffic is unacceptable. In this way, the tunnel controller 115 may balance the level of encryption to be applied based on how trustworthy a particular network element 130 is against the potential degradation in performance for traffic flowing through the tunnel due to the overhead of the additional encryption/security measures.

The tunnel controller 115 may select network elements from the tunnel database 120 that are associated with a network element 130 that is determined to be untrustworthy (i.e., has a level of trust below a threshold such that communications flowing through the network element 130 cannot be sufficiently trusted) to act as the tunnel initiator 135 and/or tunnel end 140 as discussed above. In making this selection, the tunnel controller 115 may select network elements that are able to implement the security parameters that are desired for the determined degree of trust for the network element 130. In other embodiments, the tunnel controller 115 may consider the breakdown in the sources 145/destinations 150 for traffic that typically flows through the network element 130 using IP addresses and/or other indications and select those network elements for the tunnel ends 135 and 140 that can more efficiently direct the traffic to those destinations.

When configuring the tunnel, the tunnel controller 115 may configure a single tunnel or more than one tunnel for the traffic flowing through the network element 130. For example, the tunnel controller 115 may configure a plurality of tunnels having a common initiation point 135 for a plurality of groups of traffic, respectively, directed to different destinations. Moreover, the traffic that typically flows through the network element 130 may be categorized into different groups such that the various groups may benefit from being communicated through tunnels that use different parameters. Accordingly, the tunnel controller 115 may configure a plurality of tunnels having different parameters for different groups of traffic, respectively. The tunnel parameters may include, but are not limited to, tunnel type, tunnel endpoints, tunnel security parameters, and/or tunnel filter characteristics for admitting/denying traffic to the tunnel.

The flowchart of FIG. 2 illustrates the architecture, functionality, and operations of some embodiments of methods, systems, and computer program products for configuring a tunnel for traffic associated with a network element based on whether the network element can be trusted. In this regard, each block represents a module, segment, or portion of code, which comprises one or more executable instructions for implementing the specified logical function(s). It should also be noted that in other implementations, the function(s) noted in the blocks may occur out of the order noted in FIG. 2. For example, two blocks shown in succession may, in fact, be executed substantially concurrently or the blocks may sometimes be executed in the reverse order, depending on the functionality involved.

Some embodiments of the present invention may be illustrated by way of example. Some time in the past, the verification system 110 checked the configuration of Mindy's residential gateway such that an initial acceptable hash result is recorded. After expiration of a timer, the verification system 110 re-checks Mindy's gateway to record recent hash results. Mindy then initiates a high-quality SIP videoconference. The verification system 110 either re-checks Mindy's gateway to generate a new hash result or accesses the most recent hash result and performs a compare with the initial acceptable hash result. The verification system 110 determines that a change has occurred such that the level of trust for Mindy's gateway has been compromised. The verification system 110 reports a degree of trust for Mindy's gateway as 6 out of 10 to the tunnel controller 115. The tunnel controller 115 consults the tunnel database 120 to determine that for a trust value of 6, traffic associated with the gateway should be routed through the gateway via a secure tunnel. A software client on Mindy's PC happens to be the only tunnel initiator 135 available so the tunnel controller 115 chooses it. Because the videoconference has already been attempted, the type of traffic and destination IP address is known, so an appropriate tunnel end 140 is selected close to that destination 150.

The tunnel controller 115 selects a set of tunnel parameters and sends them to the software client (tunnel initiator 135) and tunnel end 140, which causes the two elements to cooperatively set up a tunnel between them. Subsequently, videoconference traffic is put into the tunnel so that Mindy's traffic is conveyed through her un-trusted gateway in a protected fashion. Because the tunnel controller 115 knew the type of traffic at the start and the tunnel initiator and tunnel end happened to be compatible and were able to implement the chosen security parameters based on the degree of trust determined for Mindy's gateway, the tunnel monitor 125 does not detect any faults or errors in the tunnel. If errors or faults were detected, then the tunnel controller 115 would re-visit part or all of the tunnel provisioning process so as to arrive at a satisfactory configuration that would generate no or an acceptable level of errors or faults.

Periodically, the tunnel monitor 125 checks the status of the tunnel from information obtained from the tunnel initiator 135 and tunnel end 140. Faults or errors may cause alerts or alarms to be generated if intervention by an administrator would be beneficial and/or a partial or full re-provisioning of the tunnel may also be initiated. In addition, changes in the type of traffic and/or the traffic destination may cause re-provisioning of the tunnel end 140 and/or may cause additional tunnels or tunnel ends 140 to be set up with appropriate filtering/routing to ensure proper traffic delivery.

Many variations and modifications can be made to the embodiments described herein without substantially departing from the principles of the present invention. All such variations and modifications are intended to be included herein within the scope of the present invention, as set forth in the following claims.

That which is claimed:

1. A method of operating a communication network, comprising:
determining whether a network element can be trusted; and
configuring a tunnel for traffic associated with the network element based on whether the network element can be trusted.

2. The method of claim 1, wherein determining whether a network element can be trusted, comprises:
generating a first hash value based on data associated with the network element;
generating a second hash value based on the data associated with the network element; and
comparing the first hash value with the second hash value to determine whether the network element can be trusted.

3. The method of claim 2, wherein comparing the first hash value with the second hash value to determine whether the network element can be trusted comprises comparing the first hash value with the second hash value to determine a degree of trust for the network element.

4. The method of claim 1, wherein configuring the tunnel comprises:
configuring the tunnel using rules that are based on network element trust information.

5. The method of claim 4, wherein configuring the tunnel comprises:
selecting tunnel parameters using rules that are based on the degree of trust for the network element, the tunnel parameters comprising tunnel type, tunnel endpoints, tunnel security parameters, and/or tunnel filter characteristics for admitting/denying traffic to the tunnel.

6. The method of claim 5, wherein selecting tunnel security parameters comprises:
selecting encryption parameters;
determining an impact of the security parameters on the traffic; and
adjusting the encryption parameters if the impact is unacceptable.

7. The method of claim 6, further comprising:
associating at least one tunnel initiator and at least one tunnel end with the network element; and
wherein configuring the tunnel comprises selecting one of the at least one tunnel initiator and one of the at least one tunnel end for the tunnel.

8. The method of claim 7, wherein selecting one of the at least one tunnel initiator and one of the at least one tunnel end for the tunnel comprises selecting one of the at least one tunnel initiator and one of the at least one tunnel end for the tunnel that are able to implement the security parameters.

9. The method of claim 2, wherein generating the first hash value and generating the second hash value comprise:
generating the first hash value and the second hash value responsive to at least one of an expiration of a timer, a packet count associated with the network element, an event associated with then network element, and a hash generation command.

10. The method of claim 1, wherein configuring the tunnel comprises:
configuring a plurality of tunnels having a common initiation point for a plurality of groups of traffic, respectively, directed to different destinations; and/or configuring a plurality of tunnels having different parameters for a plurality of groups of traffic, respectively, the tunnel parameters comprising tunnel type, tunnel endpoints, tunnel security parameters, and/or tunnel filter characteristics for admitting/denying traffic to the tunnel.

11. The method of claim 1, further comprising:
monitoring the traffic through the tunnel; and
adjusting parameters associated with the tunnel based on the monitored traffic, the tunnel parameters comprising tunnel type, tunnel endpoints, tunnel security parameters, and/or tunnel filter characteristics for admitting/denying traffic to the tunnel.

12. The method of claim 1, wherein the network element carries the traffic within the tunnel.

13. A computer program product for operating a communication network, comprising:
a computer readable storage medium having computer readable program code embodied therein, the computer readable program code being configured to carry out the method of claim 1.

14. A communication network, comprising:
a verification system that is configured to determine whether a network element can be trusted; and
a tunnel controller that is configured to configure a tunnel for traffic associated with the network element based on whether the network element can be trusted.

15. The communication network of claim 14, wherein the verification system is further configured to generate a first hash value based on data associated with the network element, generate a second hash value based on the data associated with the network element, and compare the first hash value with the second hash value to determine whether the network element can be trusted.

16. The communication network of claim 15, wherein the verification system is further configured to compare the first hash value with the second hash value to determine a degree of trust for the network element.

17. The communication network of claim 16, wherein the tunnel comprises a tunnel initiator and a tunnel end such that the network element is configured to carry the traffic within the tunnel, and wherein the tunnel controller is further configured to configure the tunnel using rules that are based on the degree of trust for the network element.

18. The communication network of claim 17, wherein the tunnel controller is further configured to select tunnel parameters using rules that are based on the degree of trust for the network element, the tunnel parameters comprising tunnel type, tunnel endpoints, tunnel security parameters, and/or tunnel filter characteristics for admitting/denying traffic to the tunnel.

19. The communication network of claim 14, wherein the tunnel controller is further configured to configure a plurality of tunnels having a common initiation point for a plurality of groups of traffic, respectively, directed to different destinations; and/or to configure a plurality of tunnels having different parameters for a plurality of groups of traffic, respectively, the tunnel parameters comprising tunnel type, tunnel endpoints, tunnel security parameters, and/or tunnel filter characteristics for admitting/denying traffic to the tunnel.

20. The communication network of claim 14, further comprising:
a tunnel monitor that is connected to the tunnel controller and is configured to monitor monitoring traffic through the tunnel; and
wherein the tunnel controller is further configured to adjust parameters associated with the tunnel based on the monitored traffic, the tunnel parameters comprising tunnel type, tunnel endpoints, tunnel security parameters, and/or tunnel filter characteristics for admitting/denying traffic to the tunnel.
